(19) United States
(12) Patent Application Publication
(10) Pub. No.: US 2010/0330908 A1
(43) Pub. Date: Dec. 30, 2010

(54) TELECOMMUNICATIONS DEVICE WITH VOICE-CONTROLLED FUNCTIONS

(75) Inventors: Taisen Maddern, Melbourne (AU); Adrian Tan, Melbourne (AU)

Correspondence Address: FLIESLER MEYER LLP, 650 CALIFORNIA STREET, 14TH FLOOR, SAN FRANCISCO, CA, 94108, US

(73) Assignee: BLUEANT WIRELESS PTY LIMITED, Richmond (AU)

(21) Appl. No.: 12/821,046

(22) Filed: Jun. 22, 2010

Related U.S. Application Data
(60) Provisional application No. 61/220,399, filed on Jun. 25, 2009.
(60) Provisional application No. 61/220,435, filed on Jun. 25, 2009.

(51) Int. Cl. H04B 7/00; G10L 11/00; H04M 1/00

(52) U.S. Cl. 455/41.2; 704/270.1; 455/569.1; 704/E11.001

(57) ABSTRACT

A system and method for providing wireless voice-controlled walk-through pairing and other functionality of telecommunications, audio headsets, and other communications devices, such as mobile telephones and personal digital assistants. In accordance with an embodiment, a headset, speaker or other device equipped with a microphone can receive a voice command directly from the user, recognize the command, and then perform functions on a communications device, such as a mobile telephone. The functions can, for example, include requesting the telephone call a number from its address book. In accordance with various embodiments the functions can also include advanced control of the communications device, such as pairing the device with an audio headset, or another Bluetooth device.

### CLAIM OF PRIORITY

This application claims the benefit of priority to U.S. Provisional Patent Application No. 61/220,399 titled “TELECOMMUNICATIONS DEVICE WITH VOICE-CONTROLLED FUNCTIONS”, filed Jun. 25, 2009; and U.S. Provisional Patent Application No. 61/220,435 titled “VOICE-ENABLED WALK-THROUGH PAIRING OF TELECOMMUNICATIONS DEVICES”, filed Jun. 25, 2009; each of which applications are herein incorporated by reference.

### FIELD OF INVENTION

The invention is generally related to telecommunications, audio headsets, speakers, and other communications devices, such as mobile telephones and personal digital assistants, and is particularly related to a system and method for providing wireless voice-controlled walk-through pairing and other functionality between a headset and such devices.

### BACKGROUND

Systems currently exist that can be embedded within mobile telephones and other devices, and that allow the user to speak directly into the device and control certain functions. For example, some mobile telephones provide a voice recognition feature, which allows a user to place the telephone into a voice recognition mode, and then speak the name of a person listed in the telephone's address book. Generally this is performed by first pressing a button on the telephone, waiting for an invitation to utter a command, and then speaking the command and the name of the person. If the telephone recognizes the name, it dials the corresponding number. However, in many current systems, the voice recognition functionality is contained within the telephone itself. As such, the user must generally be close to the telephone when using the feature, both to enable the voice recognition mode, and to then speak the name of the person into the telephone. This technique does not readily lend itself to convenient usage, particularly when the user is using a headset or other audio device that may be separated by a distance from the telephone itself.

### SUMMARY

Disclosed herein is a system and method for providing wireless voice-controlled walk-through pairing and other functionality of telecommunications, audio headsets, and other communications devices, such as mobile telephones and personal digital assistants. Unlike many current systems, which require the user to generally be close to the telephone, both to enable voice recognition mode, and to speak the name of the person into the telephone, in accordance with an embodiment, a headset, speakerphone or other device equipped with a microphone can receive a voice command directly from the user, recognize the command, and then perform functions on a communications devices, such as a mobile telephone. The functions can, for example, include requesting the telephone call a number from its address book. In accordance with various embodiments the functions can also include advanced control of the communications device, such as pairing the device with an audio headset, or another Bluetooth device.

### BRIEF DESCRIPTION OF THE DRAWINGS

FIG. 1 shows an illustration of a system that allows for voice-controlled operation of headsets, speakers, or other communications devices, in accordance with an embodiment.

FIG. 2 shows an illustration of a headset, speaker, or other communications device, that provides voice-controlled walk-through pairing and other functionality, in accordance with an embodiment.

FIG. 3 shows an illustration of a system for providing voice-controlled functionality in a telecommunications device, in accordance with an embodiment.

FIG. 4 shows another illustration of a system for providing voice-controlled functionality in a telecommunications device, in accordance with an embodiment.

FIG. 5 shows an illustration of a mobile telephone and a headset, speaker, or other communication device that includes voice-controlled walk-through pairing, in accordance with an embodiment.

FIG. 6 is a flowchart of a method for providing voice-controlled walk-through pairing and other functions with a headset, speaker, or other communications device, in accordance with an embodiment.

### DETAILED DESCRIPTION

Described herein is a system and method for providing voice-controlled walk-through pairing and other functionality of telecommunications, audio headsets, and other communications devices, such as mobile telephones and personal digital assistants. Unlike many current systems, which require the user to generally be close to the telephone, both to enable voice recognition mode, and to speak the name of the person into the telephone, in accordance with an embodiment, a headset, speakerphone or other device equipped with a microphone can receive a voice command directly from the user, recognize the command, and then perform functions on a communications device, such as a mobile telephone. The functions can, for example, include requesting the telephone call a number from its address book. In accordance with various embodiments the functions can also include advanced control of the communications device, such as pairing the device with an audio headset, or another Bluetooth device.

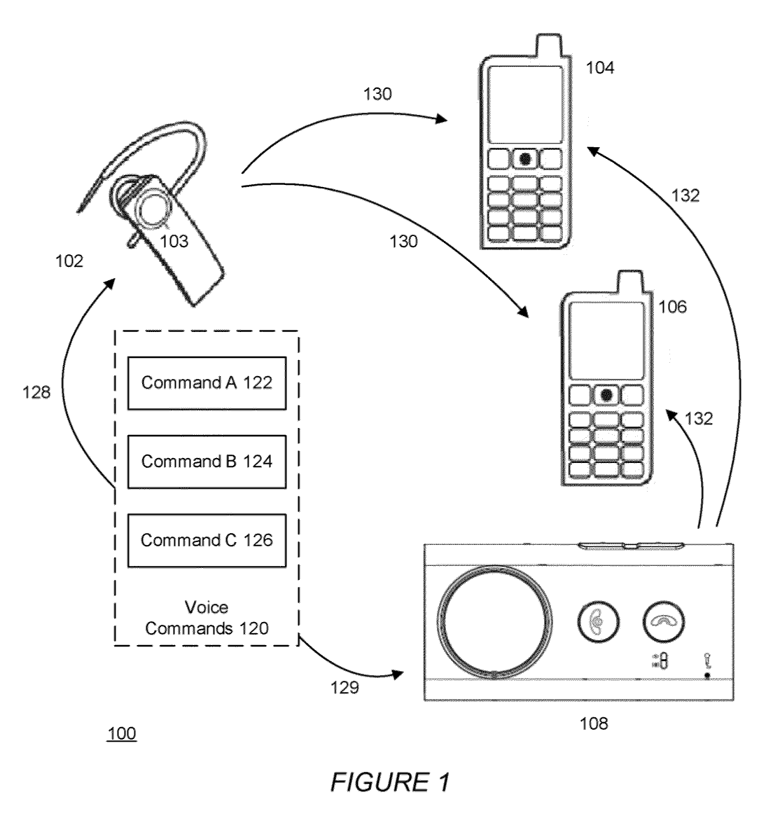

Generally, the system can be incorporated into a headset, speakerphone, or other device that a user can use for communicating via a mobile telephone, in-car telephone, or any other type of communications system. Typically, a headset (such as that shown in FIG. 1) includes an ear piece, ear hook, forward and rear microphones, and can be worn by a user with the ear piece in one of the user's ears and the hook engaged around the ear to better hold the headset in place. Alternatively the system can be provided in a speaker or other communications device, also shown in FIG. 1. The combination of forward and rear microphones allows for picking-up spoken sounds (via the forward microphone), and ambient sounds or noise (via the rear microphone), and simultaneously comparing or subtracting the signals to facilitate clearer communication.

In accordance with some embodiments, the headset, speakers and/or other devices can communicate using Bluetooth, an open wireless protocol for exchanging data over short distances from fixed and mobile devices, creating personal area networks, or another wireless technology. The headset can also function as a normal communications headset, or as an extension of the mobile phone's internal speaker and microphone system.

FIG. 1 shows an illustration of a system 100 that allows for voice-controlled operation of headsets, speakers, or other communications devices, in accordance with an embodiment. As shown in FIG. 1, a first device 102, 108 such as an audio headset or speakerphone, can communicate with and control functions of one or more other communications devices, such as mobile telephones 104, 106, speakers 108, personal digital assistants, or other devices.

In accordance with an embodiment, the first device can be a Bluetooth-enabled headset, and the other devices can be one or more Bluetooth-enabled telephones, speakers, communications systems, or other devices. In accordance with other embodiments, the first device can be a Bluetooth-enabled speakerphone, such as might be mounted on a car visor, and the other devices can again be one or more Bluetooth-enabled telephones, speakers, communications systems, or other devices.

Depending on the particular embodiment, the headset or speaker can include an action button 103, which allows the user to place the headset or speaker into a voice recognition mode. In other embodiments the headset can operate in an always-listening or passively-listening voice recognition mode that awaits voice commands from a user. Generally this requires power to be provided to the microphone, which if the headset is battery powered can drain the battery. In some embodiments, the demand on battery power can be reduced by configuring the headset to only listen for a voice command when the headset has been paired, for example when it has been specifically associated with a proximate mobile phone using Bluetooth or similar technology.

Upon activating the voice recognition mode, the user can provide voice commands 120 to the headset 128, or to the speaker 129, illustrated in FIG. 1 as voice commands A 122, B 124, C 126. As each of the voice commands are received by the headset, corresponding functions can be either sent to 130, 132, or performed on, the telephone, speaker, communications system, or other device, again using Bluetooth or similar technology. The device can similarly respond to the headset using Bluetooth signals, and the headset provides an aural response to the user.

In accordance with an embodiment, the user can command the headset and subsequently control the telephone or other device by uttering simple voice commands. A typical interaction with a headset to perform a function can include, for example:
1. The user clicks the headset action button or otherwise activates the headset's voice recognition feature.
2. The user waits for the headset to request “Say A Command”.
3. The user then speaks one of the voice commands loudly and clearly into the headset.

If the headset does not respond, the user can repeat the voice command. If the user delays too long, the headset will inform the user their previous command is “Cancelled”, and the user will have to click the action button or otherwise reactivate the headset's voice recognition feature before they can use another voice command. At any time the user can speak “What Can I Say?”, which causes the headset to play a list of available voice commands. In accordance with an embodiment, the voice commands recognized by the headset can include:
“Am I Connected?”—Find out if the headset is connected to the telephone.
“Answer”—Answer an incoming call.
“Call Back”—Dial the last incoming call received on the currently connected telephone.
“Call Speed Dial 1” to “Call Speed Dial 8”—Dial a corresponding stored speed dial.
“Call Information”—Dial a local information service.
“Cancel”—Cancel the current operation.
“Check Battery”—Check the battery level on the headset and the currently connected telephone.
“Go Back”—Return to the main menu from a “Settings Menu” or “Teach Me” option.
“Ignore”—Reject an incoming call.
“Pair Me”—Enter pairing mode.
“Phone Commands”—Access the telephone's voice dialing feature if it has one.
“Redial”—Redial the last number called on the currently connected telephone.
“What Can I Say?”—Hear a list of the currently available commands.
“Switch Headset Off”—Turn the headset off; the headset will ask for confirmation.

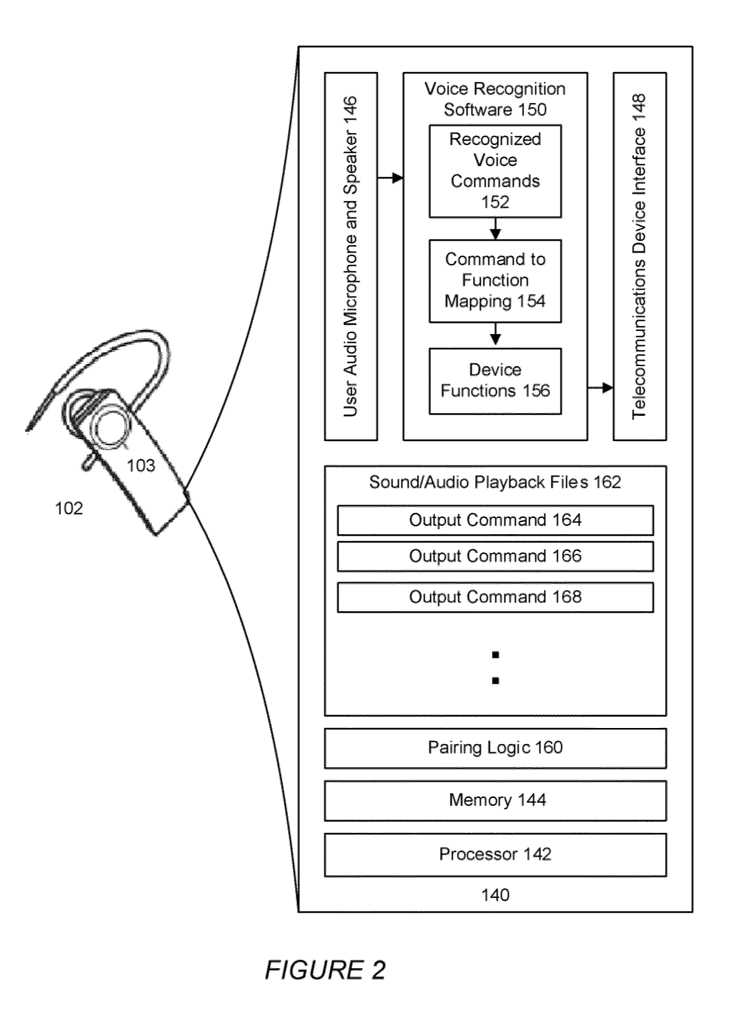

FIG. 2 shows an illustration of a headset, speakerphone, or other communications device, that provides voice-controlled walk-through pairing and other functionality, in accordance with an embodiment. As shown in FIG. 2, the headset, speakerphone or other device 102 can include an embedded circuitry or logic 140 including a processor 142, memory 144, a user audio microphone and speaker 146, and a telecommunications device interface 148. A voice recognition software 150 includes programming that recognizes voice commands 152 from the user, maps the voice commands to a list of available functions 154, and prepares corresponding device functions 156 for communication to the telephone or other device via the telecommunications device interface. A pairing logic 160 together with a plurality of sound/audio playback files and/or script of output commands 164, 166, 168 can be used to provide walk-through pairing notifications or instructions to a user. Each of the above components can be provided on one or more integrated circuits or electronic chips in a small form factor for fitting within a headset.

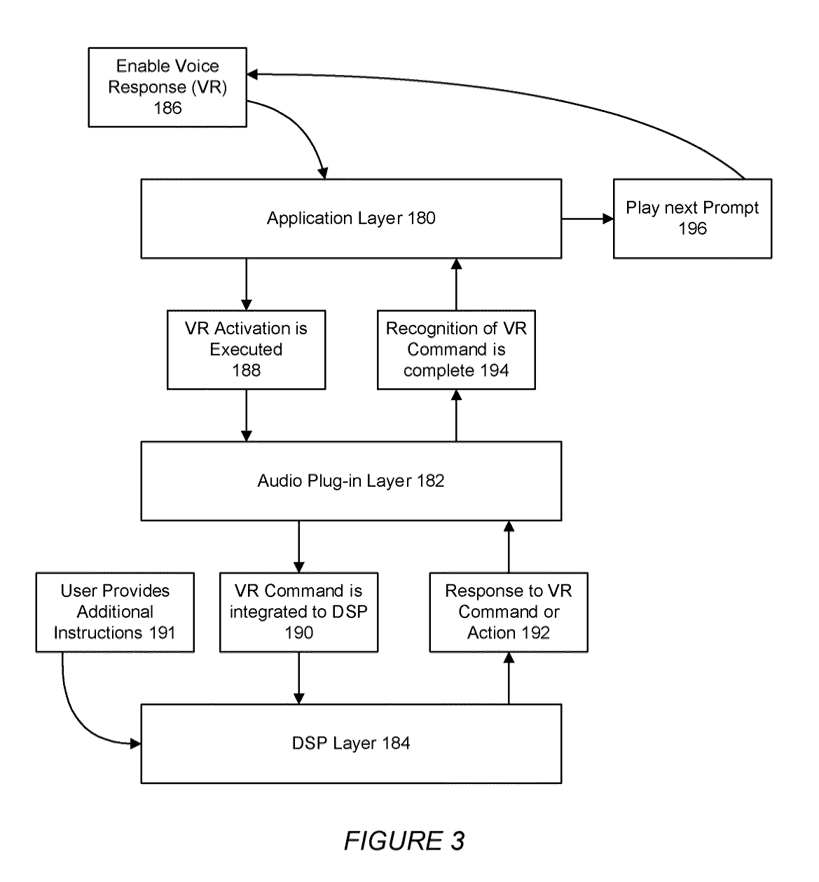

FIG. 3 shows an illustration of a system for providing voice-controlled functionality in a telecommunications device, in accordance with an embodiment. As shown in FIG. 3, in accordance with an embodiment the system comprises an application layer 180, audio plug-in layer 182, and DSP layer 184. The application layer provides the logic interface to the user, and allows the system to be enabled for voice responses (VR) 186, for example my monitoring the use of an action button, or listening for a spoken command from a user. If VR is activated 188, the user input is provided to the audio plug-in layer that provides voice recognition and/or translation of the command to a format understood by the underlying DSP layer. In accordance with different embodiments, different audio layer components can be plugged-in, and/or different DSP layers. This allows an existing application layer to be used with new versions of audio layer and/or DSP, for example in different telecommunications products. The output of the audio layer is integrated within the DSP 190, together with any additional or optional instructions from the user 191. The DSP layer is then responsible for communicating with other telecommunications device. In accordance with an embodiment, the DSP layer can utilized a Kalimba CSR BC05 chipset, which provides for Bluetooth interoperability with Bluetooth-enabled telecommunications devices. In accordance with other embodiments, other types of chipset can be used. The DSP layer then generates a response to the VR command or action 192, or performs a necessary operation, such as a Bluetooth operation, and the audio layer instructs the application layer of the completed command 194. At this point, the application layer can play additional prompts and/or receive additional commands 196 as necessary. Each of the above components can be combined and/or provided as one or more integrated software and/or hardware configurations.

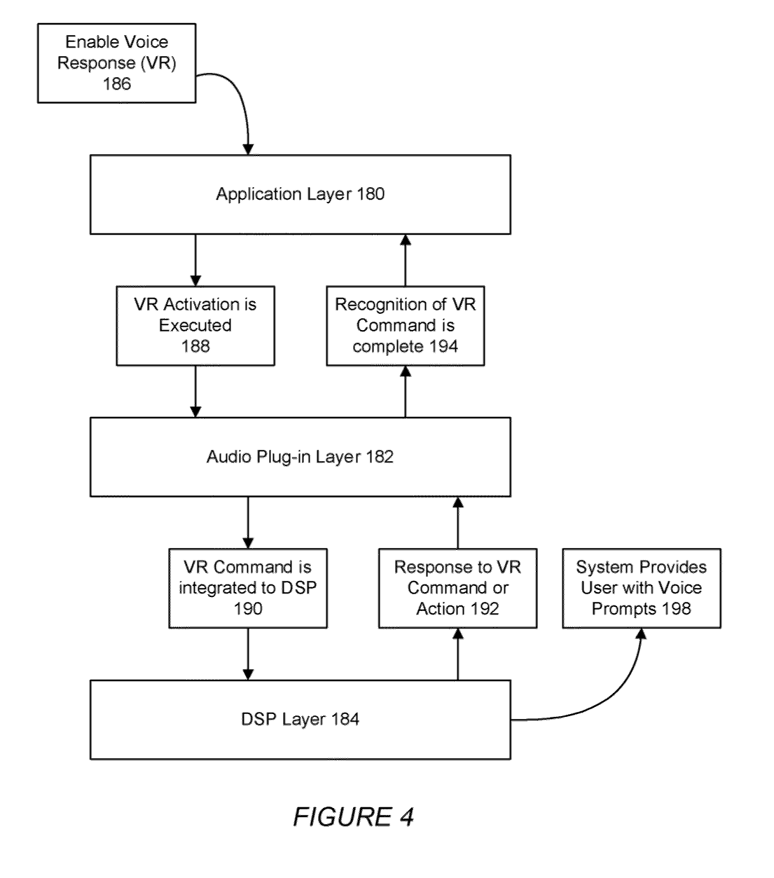

FIG. 4 shows another illustration of a system for providing voice-controlled functionality in a telecommunications device, in accordance with an embodiment. As shown in FIG. 4, in accordance with an embodiment the system can also be used to play prompts, without further input from the user. In accordance with this embodiment, the output of the audio layer is integrated within the DSP 190, but does not wait for additional or optional instructions from the user. The DSP layer is again responsible for communicating with other telecommunications device, and generating any response to the VR command or action 192, 194 except in this the DSP layer can play additional prompts 198 as necessary, without requiring further user input.

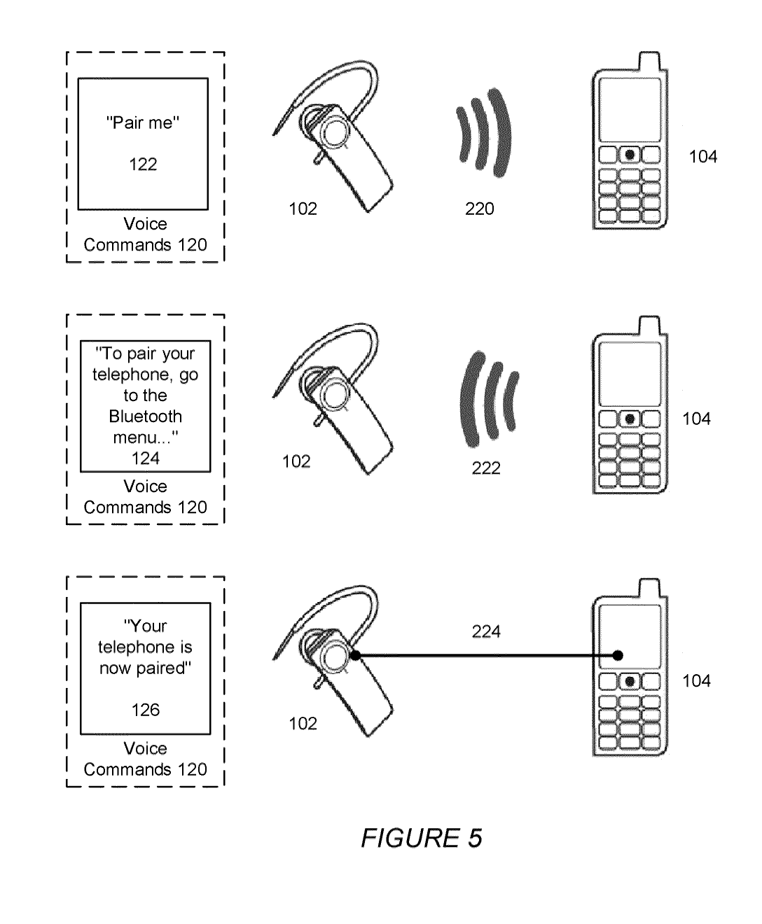

FIG. 5 shows an illustration of a mobile telephone and a headset that includes voice-controlled walk-through pairing, in accordance with an embodiment. Generally, before the user can use the headset or speakerphone with a mobile telephone, the devices must be paired, such as with Bluetooth. Pairing creates a stored link between the phone and the headset.

In accordance with an embodiment the devices can be paired using the above described voice-controlled functionality in a walk-through manner. Once the user has paired the headset with, e.g. a telephone, these two devices can reconnect to each other in the future without having to repeat the pairing process. In accordance with an embodiment the headset is configured to enter a pairing mode automatically the first time it is switched on. In accordance with some embodiments, the user can enter the pairing mode by uttering the “Pair Me” voice command, and following the voice prompts from the headset. A user can also determine whether the headset and phones are connected by uttering the “Am I Connected” voice command.

As shown in FIG. 5, a user can utter a voice command 122 to activate a function on the mobile telephone or other device, such as dialing a number using the mobile telephone or starting the pairing process. Depending on the function requested, a Bluetooth or other signal 220 can be sent to the mobile telephone to activate a function thereon. The headset can provide prompts 124 to the user, asking them to perform some additional actions to complete the process. Information can also be received from the mobile telephone, again using a Bluetooth or other signal 222. When the process is complete, the headset can notify the user with another aural response 126 and in this example, pair 224 the headset with the mobile telephone. A typical interaction with a headset to perform pairing can include, for example:
1. With the headset switched on, the user presses the headset action button, waits for the headset to ask “Say A Command”, and then says “Pair Me”.
2. Voice prompts explain to the user that the headset is now in pair mode, and the user is asked to bring the mobile telephone to within range of the headset
3. The user is then prompted to locate the Bluetooth menu in the telephone, and turn Bluetooth on.
4. The user is then prompted to use the telephone's Bluetooth menu to search for Bluetooth devices.
5. When the telephone finishes searching, it will display a list of devices it has found. The user can then select the headset from the list.
6. The telephone may prompts for a password or security code. Once entered, the telephone can connect to the headset automatically, and notify the user of success.

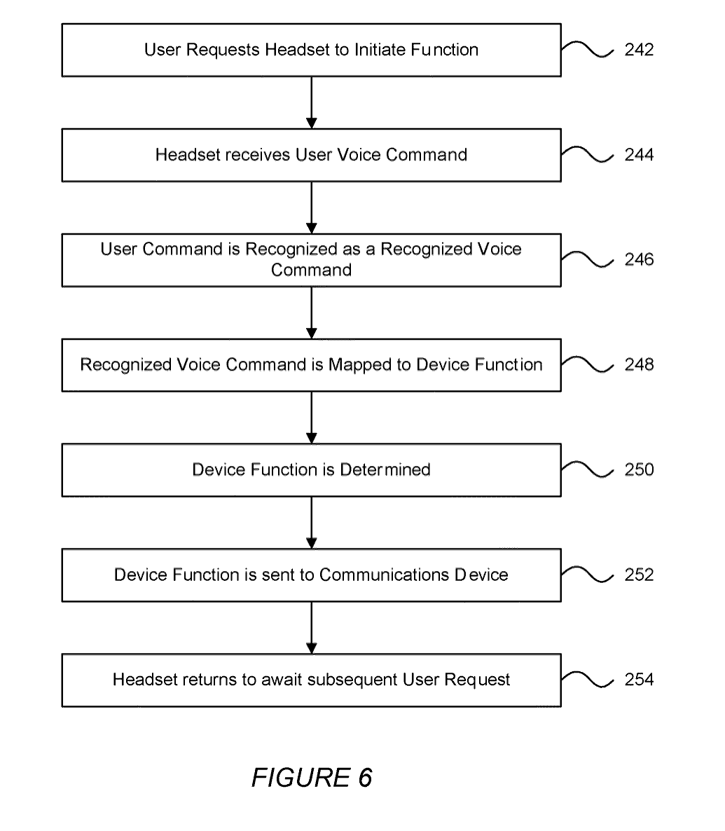

FIG. 6 is a flowchart of a method for providing voice-controlled walk-through pairing and other functions with a headset, speaker, or other communications device, in accordance with an embodiment. As shown in FIG. 6, in step 242, the user requests the headset to initiate a function on or with a communications device, such as dialing a number, or pairing with the device. In step 244, the headset receives the user voice command. In step 246, the voice command is recognized and, in step 248, mapped to one or more device functions, such as requesting the telephone dial a particular number, or initiating a pairing sequence. In step 250, the device function is determined In step 252, the device function is sent to the communications device, and in step 254, the headset returns to await subsequent user requests.

It will be evident that, depending on the voice command uttered, some voice commands and functions may require more than one back-and-forth interaction with the user. For example, the pairing sequence described above requires a number of steps, including one or more voice prompts to the user at each step. In accordance with an embodiment, a particular function may invoke a script of such voice prompts, to walk the user through using a particular function of the headset and/or the mobile telephone or other device.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. For example, voice control. It is intended that the scope of the invention be defined by the following claims and their equivalence.

Some aspects of the present invention may be conveniently implemented using one or more conventional general purpose or specialized digital computer, computing device, machine, microprocessor, or electronic circuits, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

What is claimed is:

1. A system for providing wireless voice-controlled walk-through pairing and other functionality of telecommunications, audio headsets, and other communications devices, such as mobile or cellular telephones, comprising:
an audio device having an embedded circuitry or logic including a processor, memory, user audio microphone and speaker, and telecommunications device interface; and
a voice recognition software within the audio device, that includes programming that recognizes voice commands from a user, maps the voice commands to a list of available functions, and prepares corresponding device functions for communication to and from the telephone or other device via the telecommunications device interface and a wireless protocol.

2. The system of claim 1, wherein the audio device is a headset.

3. The system of claim 1, wherein the audio device is a speaker or in-car speakerphone.

4. The system of claim 2, wherein the headset, speakerphone, speaker, or other communication device includes an action button that allows the headset to be placed into a voice recognition mode.

5. The system of claim 2, wherein the headset or speakerphone operates in an always-listening or passive-listening voice recognition mode that awaits voice commands from a user.

6. The system of claim 5, wherein the headset is configured to only listen for a voice command when the headset has been paired with another device, to reduce use of battery power.

7. The system of claim 3, wherein the headset, speakerphone, speaker, or other communication device includes an action button that allows the headset to be placed into a voice recognition mode.

8. The system of claim 3, wherein the headset or speakerphone operates in an always-listening or passive-listening voice recognition mode that awaits voice commands from a user.

9. The system of claim 8, wherein the headset is configured to only listen for a voice command when the headset has been paired with another device, to reduce use of battery power.

10. The system of claim 1, wherein the wireless protocol is Bluetooth.

11. The system of claim 1, wherein the audio device includes a script of voice commands and prompts that are then used to walk the user through activating a function on the mobile device.

12. The system of claim 7, wherein the audio device is a headset or speakerphone, speaker, or other communication device and wherein the script of voice commands and prompts are used to walk the user through pairing the headset or speakerphone with a mobile device.

13. The system of claim 8, wherein the audio device is a headset or speakerphone, speaker, or other communication device and wherein the script of voice commands and prompts are used to walk the user through pairing the headset or speakerphone with a mobile device.

14. A method for providing wireless voice-controlled walk-through pairing and other functionality of telecommunications, audio headsets, and other communications devices, such as mobile or cellular telephones, comprising the steps of:
providing an audio device having an embedded circuitry or logic including a processor, memory, user audio microphone and speaker, and telecommunications device interface;
providing a voice recognition software within the audio device, that includes programming that recognizes voice commands from a user, maps the voice commands to a list of available functions, and prepares corresponding device functions for communication to and from the telephone or other device via the telecommunications device interface and a wireless protocol;
allowing the user to request the audio device to initiate a function on or with the telephone or other device, such as dialing a number, or pairing with the device;
mapping the voice command to one or more device functions; and
sending the device function to the telephone or other device using the wireless protocol.
